(19) United States
(12) Patent Application Publication
(10) Pub. No.: US 2014/0244375 A1
(43) Pub. Date: Aug. 28, 2014

(54) REWARD DISTRIBUTION PLATFORM FOR INCREASING ENGAGEMENT

(71) Applicant: Stanley Kim, San Diego, CA (US)

(72) Inventor: Stanley Kim, San Diego, CA (US)

(21) Appl. No.: 14/189,965

(22) Filed: Feb. 25, 2014

Related U.S. Application Data
(60) Provisional application No. 61/768,861, filed on Feb. 25, 2013.

(51) Int. Cl. G06Q 30/02

(52) U.S. Cl. CPC G06Q 30/0226
USPC 705/14.27

(57) ABSTRACT

The present disclosure provides a system and method for providing relevant promotional incentives to increase engagement and participation by members of an entity, such as a non-profit, charitable institution, church or school. The present invention further provides a proactive registration system and method for increasing participation by vendors and entities.

### CROSS REFERENCE TO RELATED APPLICATIONS

This application is related to U.S. application Ser. No. 13/431,899, entitled System and Method for Fundraising for Member-Based Organizations, filed Mar. 27, 2012 and U.S. Provisional Application Ser. No. 61/768,861, entitled Reward Distribution Platform for Increasing Engagement, dated Feb. 25, 2013.

### FIELD OF THE INVENTION

The present disclosure provides a system and method for providing relevant promotional incentives to increase engagement and participation by members of an entity, such as a non-profit, charitable institution, church or school. The present invention further provides a proactive registration system and method for increasing participation by vendors and entities.

### SUMMARY OF THE INVENTION

The present disclosure provides a distribution platform that collectively aggregates promotional rewards and selectively distributing the rewards to a network of recipients for increasing engagement and participation in charitable and non-profit activities, for example, donating or volunteering, for a member-based entity. In a more preferred embodiment, there comprises an online collective rewards network and method for providing relevant rewards to members of an entity, particularly to a non-profit, charitable institution or school, or school organization. Preferably, such rewards are derived by pairing the distinguishable characteristics of the members of the entity with the target characteristics of the vendor, such characteristics include geographic segmentations (their location), demographic/socio-economic segmentation (gender, age, income occupation, education, sex, household size, and stage in the family life cycle), psychographic segmentation (similar attitudes, values, and lifestyles), behavioral segmentation (occasions, degree of loyalty), product-related segmentation (relationship to a product), affiliations or relationships (such as membership, alumnus status, parent, grandparent, sibling or other relationship) and the like.

### BRIEF DESCRIPTION OF THE DRAWINGS

FIG. 1 is a schematic flow diagram of the distribution platform.

FIG. 2 is a schematic flow diagram that illustrates exemplary engagement techniques.

FIG. 3 is a schematic flow diagram that illustrates exemplary rewards.

FIG. 4 is a schematic flow diagram of a distribution system and method for providing relevant promotions to a member-based entity.

FIG. 5 is a schematic flow diagram for a subsystem for offering promotions derived by pairing the distinguishable characteristics of the members of the entity with the target characteristics of the vendor.

FIG. 6 is a diagram of a proactive registration system to add new vendors and member-based entities. Paragraph 38

FIG. 7 illustrates an exemplary cyclical loop to proactively add new vendors and member-based entities. Paragraph 39

FIG. 8 illustrates exemplary registration of a business for choosing proximal entities/members/recipients 802 based on a proximity 804 to business as shown on a map. Paragraph 39

FIG. 9 illustrates a method or system for actively identifying consumer preferences or trends. Paragraph 45

FIG. 10 illustrates a method for assaying active purchasing behavior. Paragraph 48

FIG. 11 illustrates a method to maximize the distribution (temporally, spatially or frequency, or such other limiting tools such as expiration dates) of a promotion to affect the most number of recipients and/or reduce inundation of the promotion. Paragraph 48.

FIG. 12 illustrates the invention system that collectively aggregates vendors and/or promotions through a network of recipients. Paragraph 51

FIG. 13 illustrates an exemplary automated queue system. Paragraph 54

FIG. 14 is an illustration of data stores for storing information that can be valuable for communication with the recipients and their members with the vendors participating in the invention system, and any affiliations between the two. Paragraph 40.

FIG. 15 is an illustration of a of a computer system that can perform the methods of the invention.

FIG. 16 is a diagram illustrating portals for activating the system pursuant to a user's (or registrant's) initiation of a transaction.

### DETAILED DESCRIPTION

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well-known features may not have been described in detail to avoid unnecessarily obscuring the invention.

The present disclosure provides a distribution platform that collectively aggregates promotional rewards and selectively distributing the rewards to a network of members of an entity for increasing engagement and participation in charitable and non-profit activities, for example, donating or volunteering, for a member-based entity. In a more preferred embodiment, there comprises an online collective rewards network and method for providing relevant rewards to members of an entity, particularly to a non-profit, charitable institution or school, or school organization. Preferably, such rewards are derived by pairing the distinguishable characteristics of the members of the entity with the target characteristics of the vendor, such characteristics include geographic segmentations (their location), demographic/socio-economic segmentation (gender, age, income occupation, education, sex, household size, and stage in the family life cycle), psychographic segmentation (similar attitudes, values, and lifestyles), behavioral segmentation (occasions, degree of loyalty), product-related segmentation (relationship to a product), affiliations or relationships (such as membership, alumnus status, parent, grandparent, sibling or other relationship) and the like.

The preferred present invention contemplates a fundraising and volunteer management mechanism for entities to increase participation and engagement through the proactive registration and matching of vendors and the entity (aka recipient). Preferably, such system is adaptive, more preferably self-adaptive.

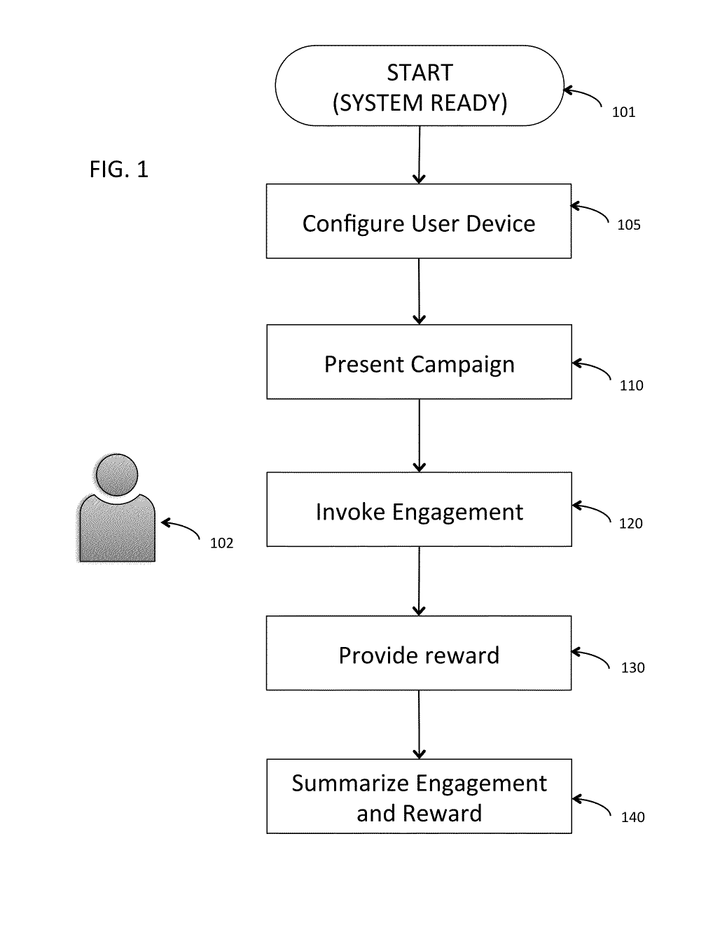

FIG. 1 illustrates selected steps of a process 100 for distributing the rewards to a network of recipients. The method may be performed by the system 100, the member's devices, or a combination of the two. At flow point 101, the system 100 and at least some of the member's devices are powered up, connected to the network, and otherwise ready to perform the following steps. In step 205, the system 100 communicates with a device 180 of a member, and configures the device 180 to present some preselected campaign. The campaign can be any project or goal identified by the member-based entity as a need by the entity, including for example, fundraising goals, projects, an acquisition or acquisitions, an event, participation goal, activity or such other need as determined by the entity. The campaign may have one or more specific or non-specific requests for at least one member to undertake, particularly a request that invokes the member to engage with the campaign, and indirectly, entity. The request can be accepted, ignored or denied by the member. Depending on requirements of the request, a reward can be provided to the member that can be redeemed immediately or at some future time. Member can be presented with a summary of the response and reward. The member's response to the campaign can be stored, transmitted, displayed, and/or otherwise used to further analyze or evaluate.

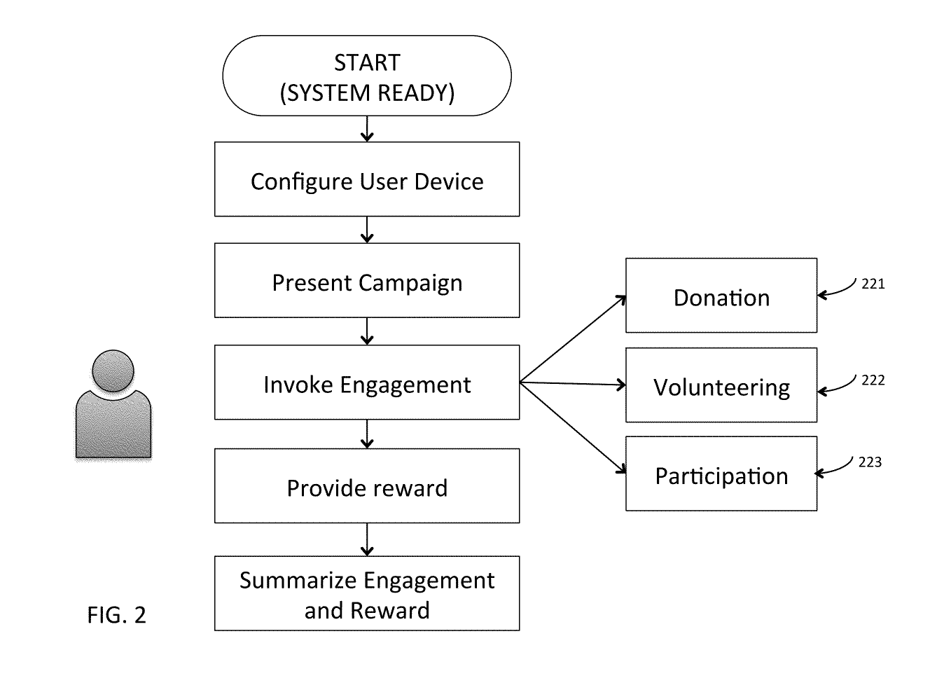

Engagement and/or participation in the campaign can be measured in several ways, including, as shown in FIG. 2, by donations, volunteering or participation. For example, member can donate money, services or products, volunteer a minimum number of hours, raise money, partake in an activity such as read books or work in a kitchen, host or organize an event, and the like. Preferably, engagement and/or participation, particularly minimum engagement/participation is established by the vendor and/or recipient. Alternatively, engagement and/or participation is established by the individual member. Engagement/participation can be based on the individual or one or more individuals. For example, a minimum number of contributors or minimum amount of a donation for the reward to be released, e.g., a reward can be released upon certain minimum dollar amount being committed by a group of members. As described herein, fundraising refers to for-profit or non-profit, charitable or non-monetary, activities that benefit one or more recipients.

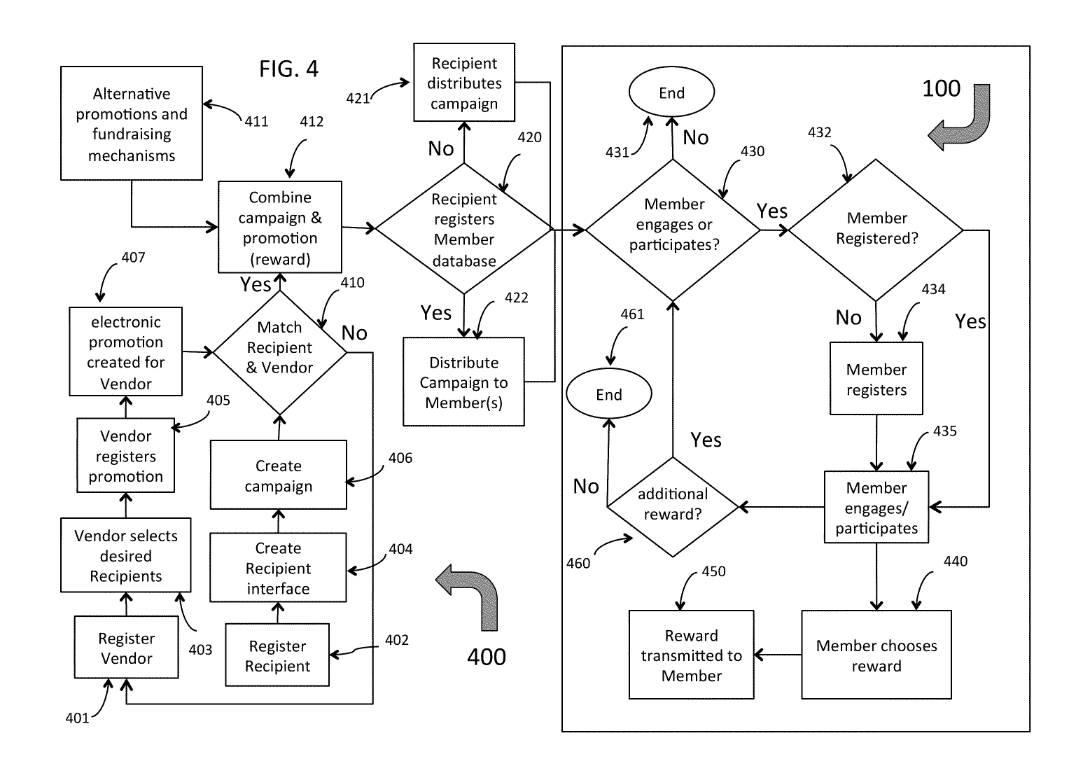

FIG. 4 illustrates a detailed flow process for the distribution platform. As illustrated in FIG. 4, vendors such as businesses, service providers, shops, manufacturers, restaurants, and the like will register 401 with the system 400. Through the registration process, certain identifying characteristics will be identified such as location and, optionally, target customers, of vendor, which can be used to characterize potential partner recipients. General information about the vendor can be used to generate a “picture” of the vendor to be used to promote vendor in system. Such information can include images or descriptions, including name, address, product or service provided, affiliations such as alumni status or relationships (e.g., parent of child at school or organization), membership, interest, demographic member, location or proximity, business interest, or other such information, or other such distinguishable characteristic (as described above). Preferably, vendor may expressly identify particular target recipients 403, such as local schools, non-profits or charitable organizations. Recipients of the system can also be other organizations with fixed memberships and/or other engaged patronage. Most preferably, the system 400 will identify specific potential target recipients in proximity to vendor, identify a class or pool of potential target recipients in proximity to vendor for vendor to choose amongst, and/or request vendor to identify characteristics of potential target recipients.

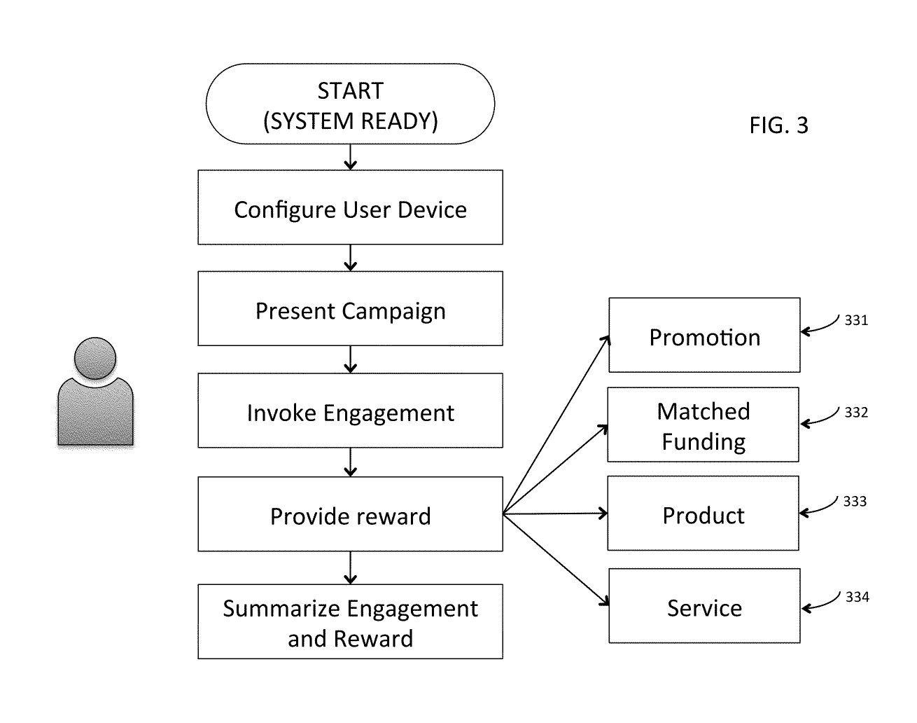

Preferably, the system manages a plurality of vendors that choose to participate in the invention system. Upon registration, each vendor will submit one or more potential promotional rewards for distribution 405. As illustrated in FIG. 3, the rewards can be promotions 311 and deals (the terms ‘reward’ and ‘promotion’ may be substituted for one another) that preferably include any manner in which the vendors will engage consumers directly or indirectly. For example, vendors can provide services 314 or products 313 which can be donated, acquired, distributed or shared with participating recipients, including, but not limited to, sales incentives, rebates, vouchers, redeemable gift certificates, coupons, advertisements, raffles, tickets, auctions, freebies, discounts, and the like, and particularly include sales incentives such as BOGO (or Buy One (or more) Get One (or more)), discounted gift certificates, discount coupons, discounted or free products and services, matching programs (e.g., dollar for dollar) 312, donations, in-kind services, and the like. An electronic representation 407 of such promotion can automatically or manually be created by the system 400, e.g., by a promotion template filled in by the vendor or other party. In addition, multiple promotions can be input into the system for each vendor.

The promotion preferably includes at a minimum such terms as are legally sufficient to define the offer that a transactions represents, or more generally a description to suffice as an advertisement. Accordingly, offer information may, and usually will include such information as a product or service description and/or the price and/or discount to be applied, maximum and/or minimum value, exclusions, vendor description, etc. If the transaction is for entry or admission for an event or venue, the relevant information in the promotion can include discount, the event information, the discount or value of the promotion, the date, and the name or identifier for the event or venue. If only certain merchants or locations will honor an offer, for example, specific franchisees, that information also will be included. Offer information also may include expiration dates, limits, and other terms and conditions imposed by a vendor. In addition to information supplied by the vendor, the system may generate information to assist in the prosecution of the promotion. For example, the system may generate or include a transaction identifier that may be unique to a particular recipient and/or member, transaction or transaction type, the vendor, and the like. The system may also generate offer codes to assist in tracking the effectiveness of campaign, and usually will include such codes if a manufacturer, franchisor, or other third party will reimburse a vendor who honors the electronic transaction. System may also comprise a guide, wizard or template for vendors to input promotions. Certain rewards may also require minimum contributions, e.g., certain types or amounts of engagement, for example a minimum or maximum amount being donated by the member. The promotion may be time sensitive, or quantity sensitive to limit promotion accessibility.

In parallel, although not necessarily simultaneously, recipients will register with the system 402 providing its contact information, address, representative of entity, method of preferred payment and other payment account, etc. Recipients contemplated by the present invention include organizations or entities with distribution lists such as membership lists, which include schools, school organizations, non-profits and charitable organizations. Upon registration, recipient will have the option to create a customized interface for its campaign 404 or to use the standard system interface 404. Preferably, a customized interface is prepared initially and maintained through a template that is customizable to and for recipient requiring minimum input from recipient, e.g., URL, logo, color choice, pattern, photos and other images, and the like. Alternatively, the interface is based on existing web templates unique to recipient. The interface can be used as a primary or secondary site for recipient, or as an alternate or complementary site. Preferably, the interface can be the template for the recipient to promote the campaign 412. It can also be used as a template for the recipient to provide information about the recipient, e.g., as the primary website or as an electronic newsletter or flyer. Such information can be manually input or auto-generated. In addition to the promotion, the interface can be used to promote additional alternative promotions or fundraising mechanisms 411, such as auctions, raffles, and advertisements or for programs, such as reading and math programs for schools and parents.

As further illustrated in FIG. 4, recipient will be matched with vendor and/or promotion 410. Preferably, promotion will be automatically selected by the system based on location of vendor and recipient. Alternatively, or in addition to location, selection is predetermined based on the registration requests of both parties. Depending on the recipient, an administrator for the recipient may select each vendor and/or promotion, or disqualify certain vendors, promotions, industries, vendor groups, etc., e.g., certain entities such as schools may not desire liquor stores to participate in their pool of vendors. Most preferably, vendors will register with certain recipients added as their pool of potential recipients, and in parallel, recipients will register with certain vendors or classes of vendors be added as their pool of potential vendors. If vendors with promotions are already registered in the system when recipient registers or requests additional promotions, recipient can select those specific vendors and/or promotions it will qualify or disqualify as recipient's selected vendors. If there are no matches, for example, there are no suitable vendors or promotions suitable in the system, the system will wait until a suitable promotion is available, whereupon the promotion will be integrated into the recipient's interface. In yet another alternative, or in addition, promotions can be weighted by other factors, such as for example, by the members, e.g., a list of promotions can be voted or chosen by members.

Promotion can be distributed directly or indirectly by the system. Preferably, recipient can provide or upload contact information for its members or its distribution list to the system 420. System can transmit the promotion to recipient through a multitude of platforms 422, including email, SMS or other text message, twitter or other electronic message. It will be appreciated that the offer or promotion can be presented to user in a variety of means, including verbal, telephonic, TV or radio, mobile, electronic or written, including such methods as email, text, flyers, requests, social media tools, newsletters, advertisements, and the like. Generally, however, many recipients are hesitant to release their membership or distribution list, and prefer to send out any information to their members directly. Accordingly, in one preferred embodiment, recipient can directly send promotion information to its members and affiliates 421. This information can be sent intact, in summary (or certain portions of the promotion such as the vendor, type, discount, etc.) or represented, for example, as a website address or link directed to the promotion. Alternatively, many recipients may not have the means and resources for transmitting electronic promotions, and would require the system to transmit promotions. Preferably, the system contemplates storing recipient member information on the system.

FIG. 4 illustrates a preferred embodiment of the system of FIG. 1. A campaign is transmitted to recipient's members (including constituents, patrons, supporters, beneficiaries, distribution lists, affiliates and the like), which may be presented directly or indirectly with the promotion, including its terms and general information. The member must then decide 430 to ignore/disregard the campaign and/or promotion 431 or to engage with the campaign. As further shown in FIG. 4, the member enters the system 400 through a communication received by the system or the recipient, e.g., recipient's website or newsletter. Other pages are also contemplated, for example a login page or other information. If the member decides to engage in the campaign, the member will then proceed with registration 434 in the system, which will request certain information from the member sufficient to process the transaction (e.g., acceptance of the promotion) such as their name, address, phone, financial information and other such information. The system may further request login information such as an ID account and password, as well as confirmation of the beneficiary recipient. Additional information may also be requested. By registering with the system 434, the member can bypass many of the registration process by simply entering the system as a registered user of the system. If the member decides not to register with the system, the process ends. Registration can be detailed or minimal, for example, enough to confirm engagement or the promise to engage. If the member decides to continue registration with the system, the system then attributes the member to the recipient's database. The member may also be presented with additional promotions that the member may agree to accept or decline 460.

As will be appreciated by those in the art, a consumer need not be a member or affiliated with the recipient, but can access the system independently. Upon access, the consumer may be presented with inquiries regarding geographic information, potential recipients and similar questions to route the consumer to a particular recipient.

In a detailed perspective of the present invention, member initiates the transaction process by electronically engaging 435 (generally purchasing, buying, donating or donated, volunteering, participating, winning, acquiring, renting, leasing, gifting or gifted, requesting, organizing, and the like) in a campaign, and thereafter accepting a promotion or an offer for a good, product, service, payment and the like. For example, member may choose to donate money to a recipient, and thereafter will be presented with an online a coupon for a discount for dinner for a local restaurant advertised or promoted to user. The electronic transaction will register with system, with the proceeds of the donation sent to the recipient 450, or a beneficiary designated by the recipient. The proceeds can be sent to recipient by any means customary for recipient to receive funding. Member will receive, for example, a coupon to redeem at the restaurant. As used herein, purchasing does not necessarily require payment but can also mean acceptance of an offer, reward or promotion.

In an exemplary embodiment, the recipient is a recipient school (or it's representative such as PTA or Educational Foundation or booster) that informs and promotes to its students, teachers, parents, and general community that it is signed up with the system. The recipient school preferably present to the students, teachers, parents, and general community a campaign through a web site. Parents, relatives, and members of the community preferably visit the web site of the system and decide to participate in the engagement system 400 or by registering with the site 434. After registering 434, the parents, relatives, and community member become participants designated to a school or schools. Alternatively, a prospective participant can identify a particular school by entering such information as the state, city, school district, or particular school for which the participant desires to donate money to. The participant can view information about promotions and vendors on the system, and then determine whether to proceed with participating in the campaign and with receiving the promotion. The recipient can also be an organization such as sporting team, club or other similar organization within a larger recipient.

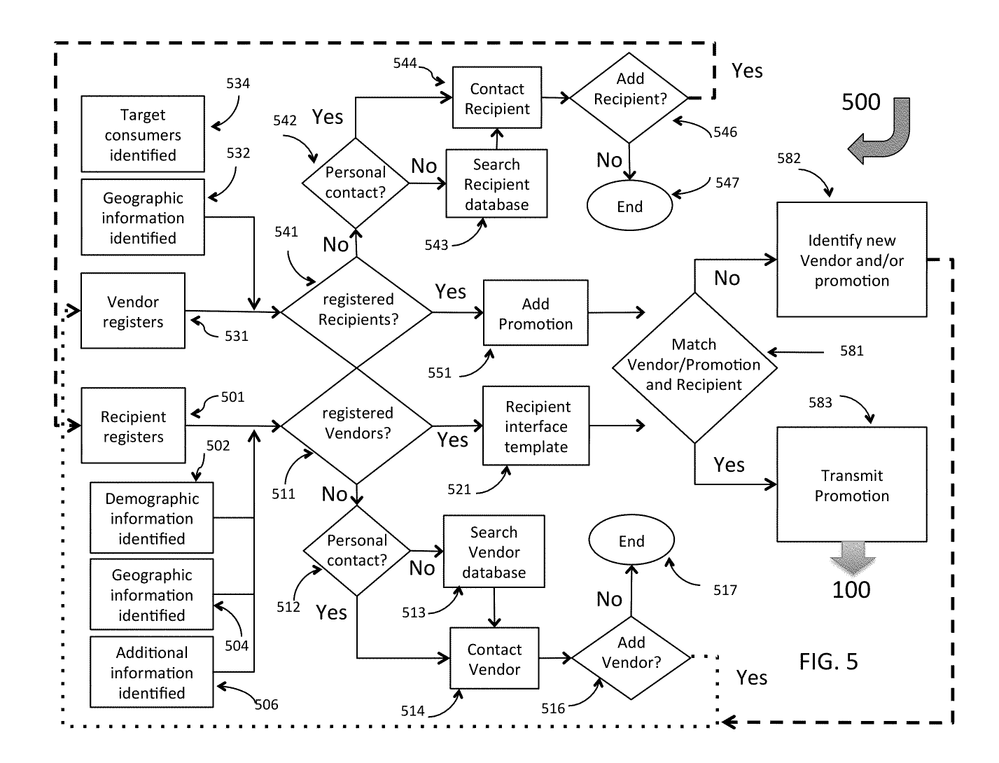

In a preferred embodiment, vendors will desire to promote certain transactions or promotions to particular recipients based on recipients and vendors location, vendor's ties to a recipient (e.g., a parent of a child in a particular school system or a member of a non-profit), vendor's target demographics (e.g., an ice cream store for schools), and the like. Accordingly, FIG. 5 illustrates a particular feature of the present invention of pairing vendors and recipients, particularly based on targeted marketing characteristics such as affiliations, geographic segmentations (their location) 532/504, demographic/socio-economic segmentation 502 (gender, age, income occupation, education, sex, household size, and stage in the family life cycle), psychographic segmentation (similar attitudes, values, and lifestyles), behavioral segmentation (occasions, degree of loyalty), product-related segmentation (relationship to a product), and the like 506/534. As recipients and vendors register with the system 501 and 531, certain characteristics are inquired and/or identified of the vendor and recipient, respectively. The system will identify potential partner recipients (for vendors) and vendors (for recipients) that may or may not be registered in the system. Preferably, the system will include a database of existing vendors and recipients, minimally preferably, recipients (e.g., non-profit database, school database, etc.).

If the respective partner is not registered in the system 511/541, irrespective of whether the general information about the respective vendor and recipient is in the system, the system may request for personal connections to the respective partner (i.e., vendors to recipients 512 and recipients to vendors 542). The system may directly contact the recipient 544 and/or vendor 514 or may search within its database for contact information regarding the respective recipient 543 and/or vendor 513, to request recipient and/or vendor join the invention system or provide information regarding the invention system. The recipient 546 and/or vendor 516 can then determine whether to accept or decline 517/547 registration. Additional recipients and/or vendors can be added through the system by this process.

If the respective partners are registered, vendors can continue to process their promotions 551 and general information, and recipients can continue to process their general information, databases and, optionally, their interface template for promotions 521. As further illustrated in FIG. 5, the system will then confirm the pairing of the vendor and/or promotion with the recipient 581. As discussed above, there may be occasions where certain potential partners, particularly recipients, do not want to be associated with particular vendors and/or promotions. If a pair is matched, the promotion can be broadcast to recipient's members 583. If a match is not made or declined, then new pairings are identified 582.

As illustrated in FIG. 5, the system is developed to more efficiently identify partner vendors and recipients. Preferably, the first registrant can be a recipient, a vendor or a consumer associated with either of the two, who will help develop the counterpart partners in the system through a series of feedback loops to identify potential new partner vendors and recipients.

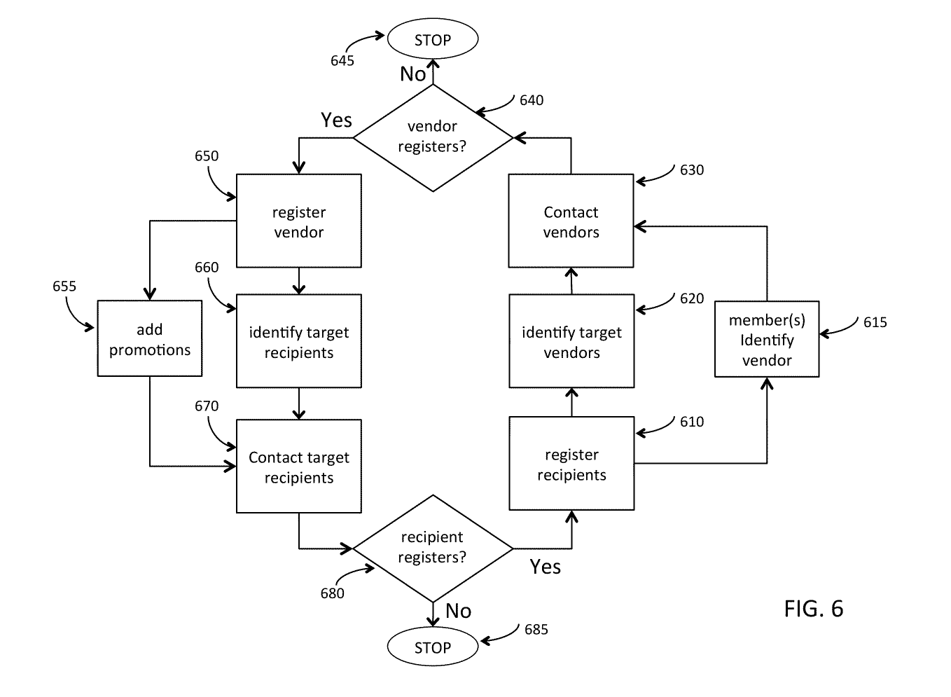

FIG. 6 illustrates a proactive registration system to add new vendors and member-based entities comprising one or more servers having a memory storage device for storing a plurality of vendors and entities and a first processing means for adding new vendors and a second processing means for adding new entities; wherein first processing means comprising identifying one or more new entities 660 with members having the target characteristics of the vendor, wherein target characteristics are selected from geographic segmentations, demographic/socio-economic segmentation, psychographic segmentation, behavioral segmentation or product-related segmentation; contacting 670 one or more new entities to register with the system, and thereafter, registering new entities 610 with the system; and wherein second processing means comprising identifying one or more new vendors 620 having target characteristics of the entities members, wherein target characteristics are selected from geographic segmentations, demographic/socio-economic segmentation, psychographic segmentation, behavioral segmentation or product-related segmentation, contacting one or more new vendors 630 to register with the system, and thereafter, registering new vendors 650 with the system. Preferably, entity will be presented with incentives 655 such as promotions or donations from one or more community vendors interested in partnering with the entity. Similarly, vendor will be presented with incentives such as evidence of member interest 615 in vendor to encourage vendor registration. System can identify personal connections such as described herein to incentivize vendor and the entity. However, if either vendor 640 or recipient 680 determines to not register, no further action need be taken 645 and 685.

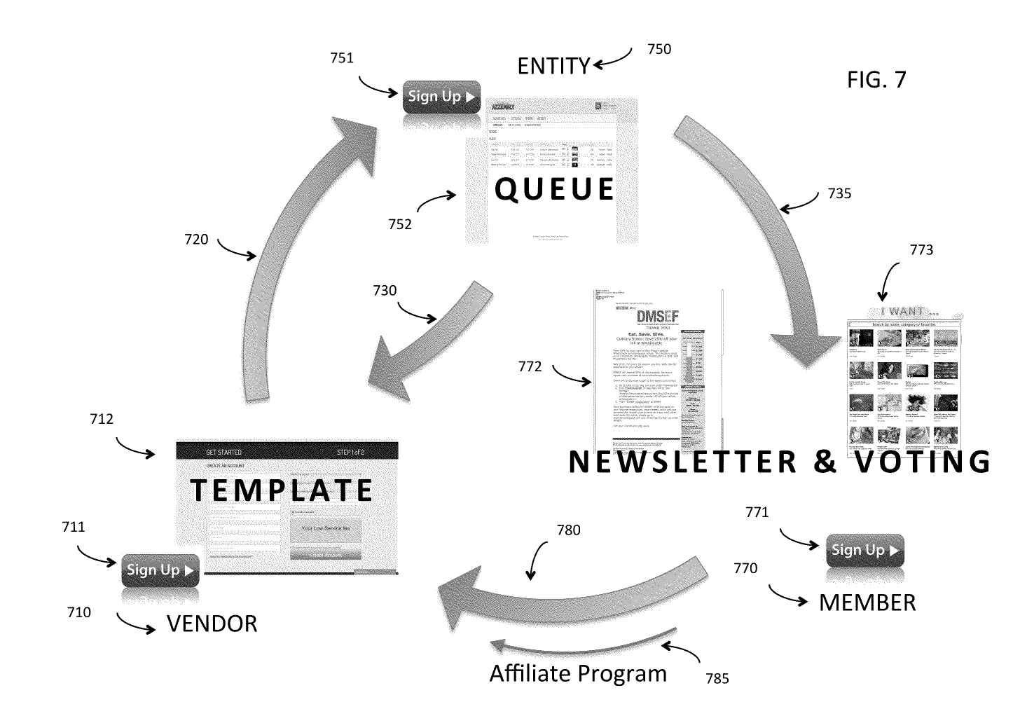

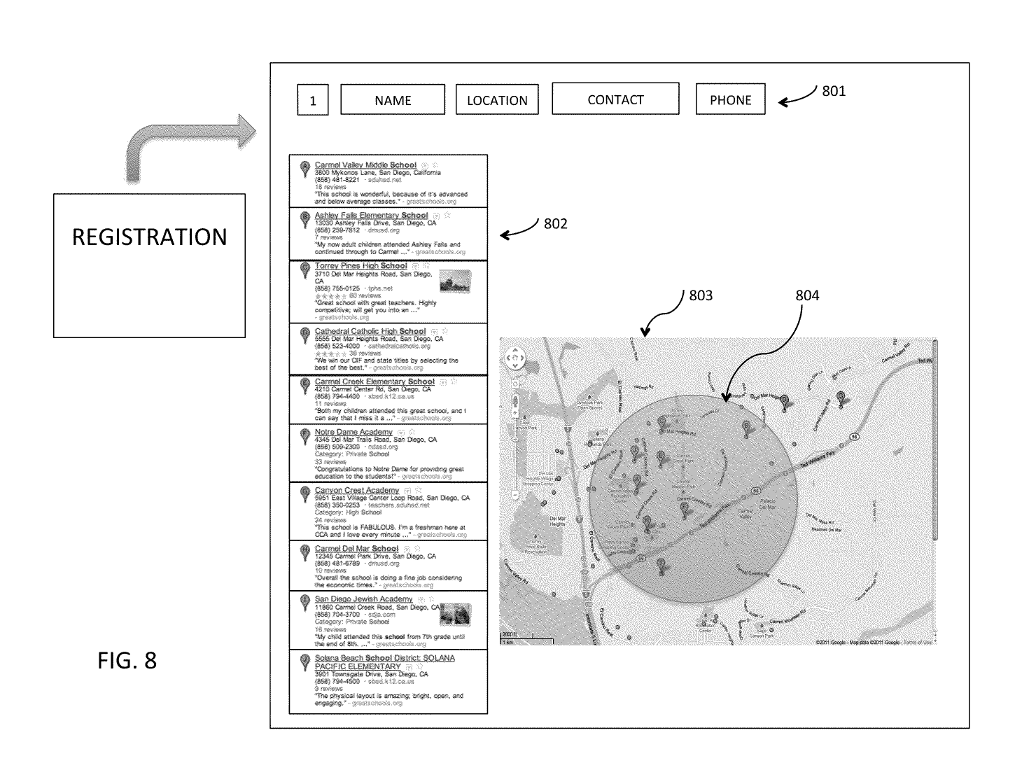

FIG. 7 illustrates an exemplary cyclical loop to proactively add new vendors 710 and member-based entities 750. The system can add any one of the three entities 710, 750 and 770 to initiate the cycle, but for exemplary simplicity, a vendor 710 will register 711 and add his promotions 712 to the system. This process can be automated and/or manual. Once vendor registers 711, vendor 710 can identify entities 650 vendor 710 desires to partner with, for example entities with member having target characteristics. FIG. 8 shows an exemplary registration 801 of a business for choosing proximal entities/members/recipients 802 based on a proximity 804 to business as shown on a map 803. One or more promotions from one or more vendors can be aggregated with any personal connections to present 720 to a member-based entity 750 to incentivize entity to register 651. Entity can decide to register 751 and manage promotions 752, e.g., a promotion queue, to incentivize its members 670 to engage more actively with entity 750, e.g., volunteer or donate. Entity can present information through multiple channels, for example a newsletter 772, website, email, mobile notice, or other means as described herein. Preferably, entity 610 can encourage greater engagement and participation through the invention system 100 and 400, e.g., providing rewards for participating and engaging in campaigns. Members can also be presented with means 780 to identify additional promotions or vendors such as through preference surveys (aka voting) 773, referral or affiliate programs that reward/incentivize referrals 785, or personal connections/networking mechanisms. To complete cycle, new vendor 710 can be requested by member(s) and recipients to participate in program/system, and encouraged to participate in engaging with the entity and it's members.

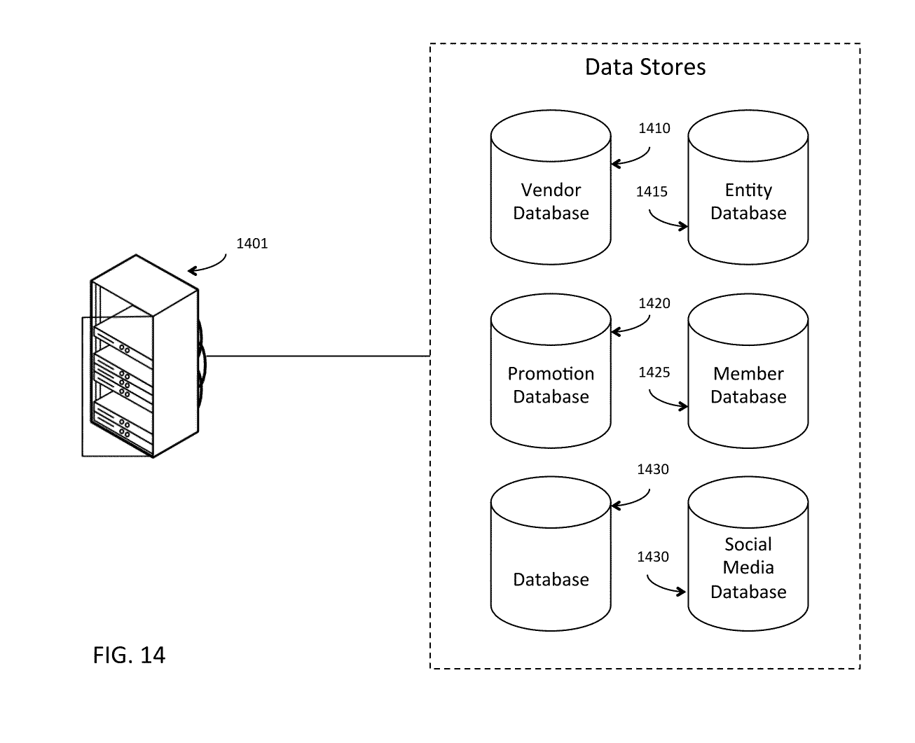

In one preferred embodiment, the system preferably includes a database (FIG. 14) for storing information that can be valuable for communication with the recipients and their members (constituents, patrons, donors, distribution lists, affiliates and the like) with the vendors participating in the invention system, and any affiliations between the two. For example, the database can store school information such as logistical data as the state, city, zip code and school district in which the participant school is located to compare against vendors in the same location.

The database preferably also includes vendor information. The vendor information preferably includes general information regarding businesses, such as industries, locations, target demographics, sales, prior promotions, employees or authorized users, and the like. As vendors utilize the system, information typically stored in the vendor information of the server database, for example, can include such information as promotional sales incentives and deals that are setup between the system and the vendors for contributions to participating recipients within the system. The promotions and deals preferably include any manner in which the vendors believe they can contribute to the participating recipients which include, but are not limited to, providing incentives for members to actively participate and engage with entity, dollar matching for member donations, discounted or free services or products, accepting predetermined dollar amounts added to bills for services provided, donating a portion of each purchase to the participating recipients, donating a specific amount per members/users making a purchase with a redeemable coupon, or merely providing a better or reduced price for members/users within the community to help participating recipients.

The vendor database may also include administrative management tools to provide statistical information regarding the value of specific promotions, purchase/engagement history and trends, tracking of redeemed transactions (vs. purchased transactions) such as redeemed discounts and coupons that are taken advantage of by consumers, and an overall usage by recipients and vendors of the system. The statistical information stored within the vendor database provides data to show what promotional sales incentives the members are utilizing for saving money for the participating recipients with the system. The database also advantageously provides overall historical background for the vendor to appreciate additional business created with participating recipients through the system.

The system preferably also includes a database that stores general information of recipients. The recipient information preferably includes general information about recipient and its members such as location such as city, state, zip code and regional affiliations (e.g., school districts), type of organization (e.g., non-profit, school or charitable organization, and more specifically e.g., primary or secondary school, law enforcement foundation, environmental group, church, etc.), general characteristics of members (e.g., parents of elementary schools, donors of non-profit, members of church, parents of school band, etc.), specific membership information such as member contact information (e.g., email, cell phone, social media contact information such as Twitter or Facebook or such other information), and the like.

The system also preferably stores transaction information pertaining to the system. Information relevant to the vendor such as purchased transactions, redeemed transactions, statistical information such as most fruitful transaction, demographics information, and the like may be tracked and viewed by vendor through a specific portal created for each vendor. Similarly, similar portals can be created for recipients, their members or other consumers registered with the site with respect to their transaction information and related statistics relevant to each entity. For example, the typical donation data stored within the system can include, but is not limited to, the amount donated to each recipient and the amount of money donated from each vendor through the system. The statistical information found in the donation data can advantageously be used by the system to provide information to the recipient, their members, and the vendors, to show how the system is working within the community to raise or save money for the recipient (and its members) through the efforts of the participating members and the vendors.

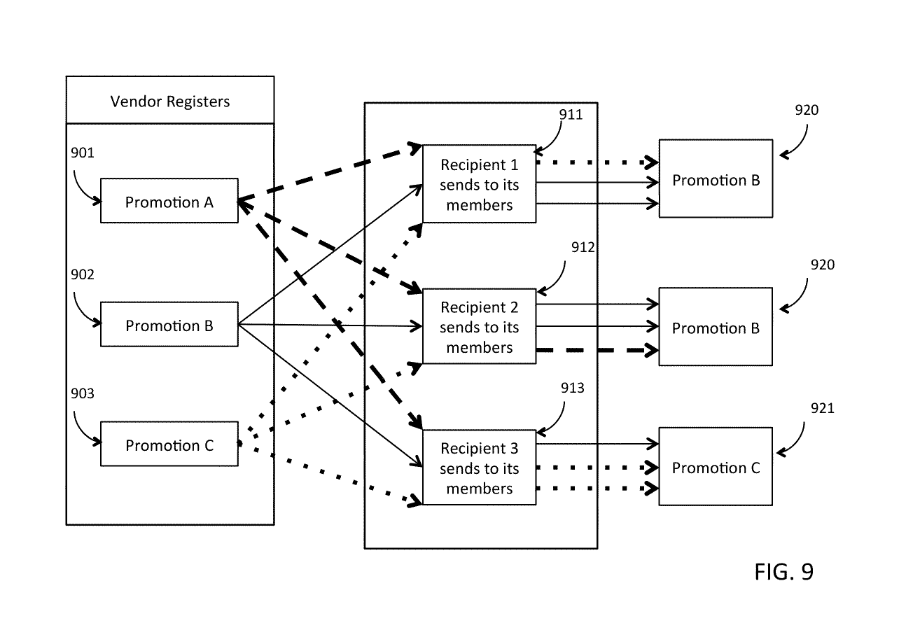

FIG. 9 illustrates a method or system for actively identifying consumer preferences or trends. Many marketing systems are available that identify consumer information such as location and demographics upon the purchase of a product or service. Such data mining tools are readily available to mine, for example, the credit card purchasing habits of an individual based on their marketing target characteristics such as location, demographics, etc. Very few tools actively test the purchasing habits of consumers by actively promoting multiple promotions, and learning behavior as they relate to the consumers affiliations with a particular organization (e.g., a recipient) and the recipients characteristics. Accordingly, the present invention further, as shown in FIG. 9, describes a method and system for actively testing consumer behavior, preferences and trends based on affiliations to an organization. FIG. 9 describes a system and method for assaying multiple promotions from a vendor(s) presented to multiple consumers (generally as they are affiliated with a particular recipient or a group of recipients). Alternatively, multiple promotions (same or similar can be from different vendors). Preferably, the promotions are closely related such as from the same vendor, same type of service or product, location, generally the same deal packaged in multiple ways (e.g., $50 for $100 of services or 50% discount for $100 or Buy One $50 certificate Get One $50 certificate free), different colors, or such other closely related yet trackable promotions. Preferably, the promotions are different in one characteristic or another. More preferably, the promotions are for services.

As further described in FIG. 9, a panel of promotions 901 902 903 are each sent to multiple consumer pools or a group of consumers 911 912 913. Preferably, the consumers 911-913 are based on their affiliations with a particular recipient. The promotions 901-903 can be sent at the same time or at differing times. Although the preference history of each individual can be measured, in order to preserve individual privacy rights, the system will preferably gather aggregate information for the pool of consumers. The purchases and non-purchases are then aggregated and analyzed to determine preferences for each pool 920 921. This information is compared against other information about the pool of consumers and recipients, such as geographic segmentations (their location), demographic/socio-economic segmentation (gender, age, income occupation, education, sex, household size, and stage in the family life cycle), psychographic segmentation (similar attitudes, values, and lifestyles), behavioral segmentation (occasions, degree of loyalty), product-related segmentation (relationship to a product), and the like to determine marketing and trend information for the pool of consumers. For example, different purchasing habits of parents can be determined based for each school, affects of donation as a motivation for non-profits in comparison to discounts, comfortable spending levels for different communities, as well as such understanding such statistics and analytics over time.

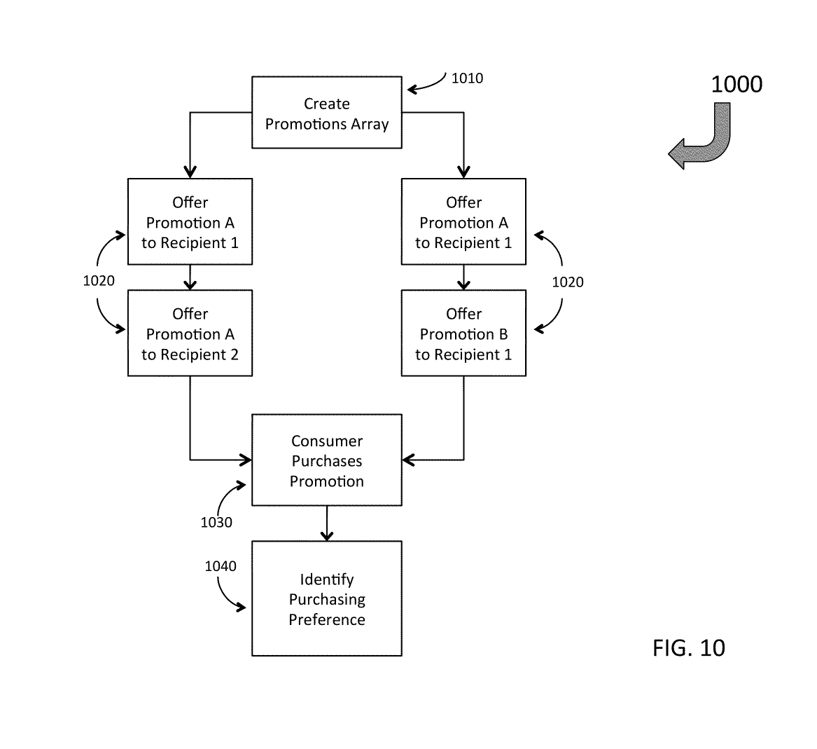

Preferably, as shown in FIG. 10, there is provided a method for assaying active purchasing behavior. From a pool of promotions 1010, similar offers are prepared for multiple recipients with common or overlapping characteristics such as interests, members, geographic location (for the recipient or it's members), demographics or other target characteristics; or alternatively, different offers are prepared for the same recipient. Recipient(s) transmits the promotions 1020, whereupon the purchase of the promotions by the consumers are recorded 1030, and analyzed to determine preference, behavior and/or trends 1040, and then further analyzed in comparison to the characteristics of the recipient.

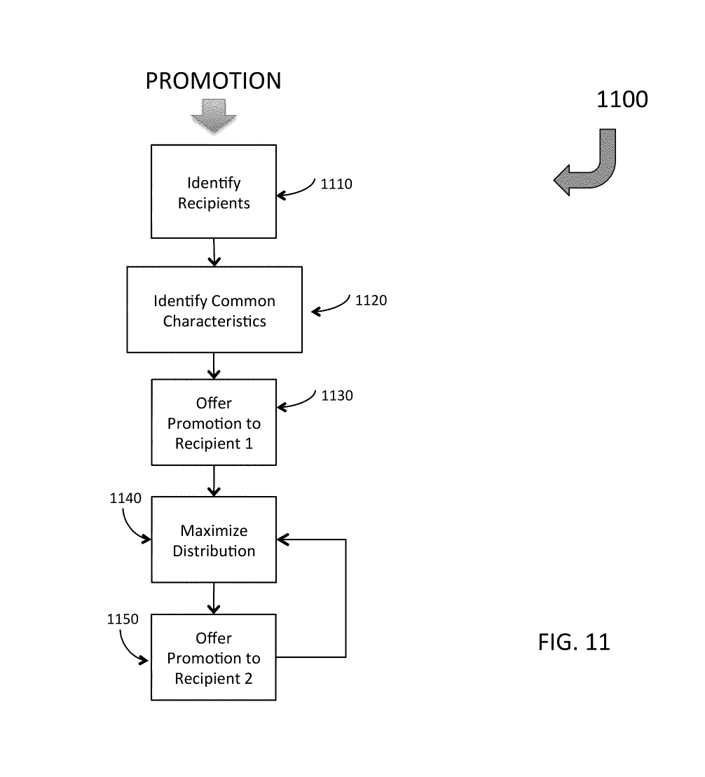

An alternate view of FIG. 10 illustrates a method or system for enhancing the value of promotions by allocating promotions temporally, geographically or by frequency. Members or other consumers of a distribution list for a recipient may inherently be affiliated with more than one recipient. Vendors may desire to allocate promotions to consumers over a large area, or longer period of time. For example, a parent (i.e., member) of a school may have multiple children at different schools within close proximity of each other. It may be favorable to distribute the promotion to each of the schools over a year to enable multiple recipients to offer the same or similar promotions (and accordingly receive any associated donated amounts) and to increase the effectiveness of the promotion. Alternatively, it may be preferable to allocate promotions to an organization within a larger recipient and a distinct recipient, then reintroduced to the larger recipient at a different time so as to reduce competition of the promotion. Preferably, as shown in FIG. 11, this can be accomplished by identifying each recipient 1110 for each vendor and/or promotion, identifying common denominators and characteristics 1120 such as geographical overlap for the group of recipients, and maximizing the distribution (temporally, spatially or frequency, or such other limiting tools such as expiration dates) 1140 of the promotion to affect the most number of recipients 1130 and 1150 and/or reduce inundation of the promotion.

It will be much appreciated by those of skill in the art, the present invention can be more broadly applied to other recipients beyond non-profits, charities and schools such as individuals, organizations, corporations and companies, and other such entities that are looking for revenue or funds.

In yet an alternative preferred embodiment of the present invention, the present disclosure provides a system and method for a collective ad network. In a more preferred embodiment, there comprises an online system and method for several organizations to collectively generate revenues, wherein each organization provides an ad or promotion to the system that is then collectively distributed amongst one or more group members. The promotions or ads are collectively added to a library of ads or promotions. In a preferred embodiment, the system is automated to identify which ads or promotions can be shared amongst the group through distinguishable characteristics of the members of the organization with the target characteristics of the ad or promotion, such characteristics include geographic segmentations (their location), demographic/socio-economic segmentation (gender, age, income occupation, education, sex, household size, and stage in the family life cycle), psychographic segmentation (similar attitudes, values, and lifestyles), behavioral segmentation (occasions, degree of loyalty), product-related segmentation (relationship to a product), and the like.

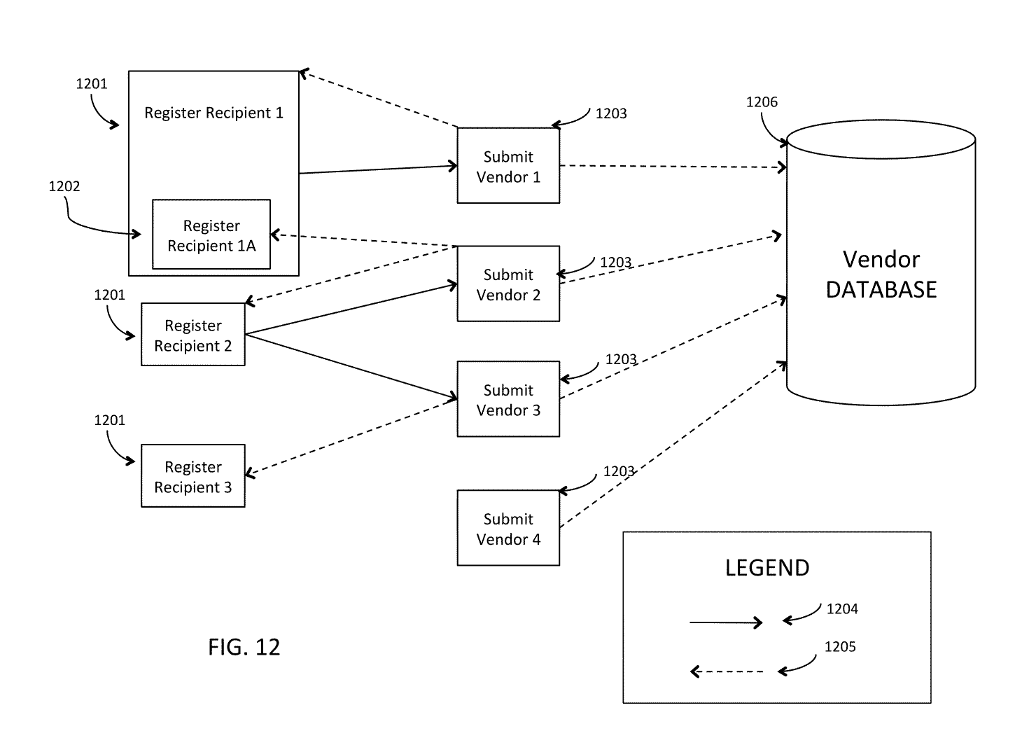

FIG. 12 illustrates the invention system that collectively aggregates vendors and/or promotions through a network of recipients 1201, which are then selectively allocated to recipients with common characteristics. Such common characteristics include geographic segmentations (their location), demographic/socio-economic segmentation (gender, age, income occupation, education, sex, household size, and stage in the family life cycle), psychographic segmentation (similar attitudes, values, and lifestyles), behavioral segmentation (occasions, degree of loyalty), product-related segmentation (relationship to a product), and the like. As shown in FIG. 12, one or more recipient 1201 (such as an individual, organization, corporation or other such entity; or a sub-entity or subgroup within a larger organization 1202) registers with the system. During the registration, recipient is asked questions to gather or learn characteristic information, or alternatively, such information can be acquired through a pre-existing database or library. Preferably, system will identify further characteristics about recipient and its members through their usage of the system. The registrant will likely be a representative member for the entity and will answer on behalf of the entity. During the process, system identifies characteristics that are common amongst two or more of recipients such as location, demographic similarities of members, purchasing or use habits of members, or other commonalities.

Vendors are presented to recipient. Preferably, vendors are chosen by the invention system automatically and presented to recipient to choose or not choose as recommendations. As described above, vendor 1203 can be automatically invited through social media tools, by personal reference or invite by recipient or by such other mechanisms to invite vendors. Alternatively, vendor can self-register or incorporated into system by an external library or database. Vendor 1203 (and promotion) is collectively downloaded to system database 1205, which is then available to the network of recipients 1201. Preferably, system automatically recommends suitable vendors 1203 and/or promotions to recipients that have common characteristic. Recommendations can be made based on requests by recipients of certain vendors, classes of promotions, industry, purchasing habits of members, characteristics of vendor and/or recipient, or such other method as further described herein. Other considerations also include the duplication of promotions or types of promotions so as to minimize competition or redundancy. For example, subgroups 802 within a larger organization 1203 (such as sporting teams and clubs within a larger school) will be provided distinctly discrete promotions and/or vendors, or types of promotions/vendors to minimize competitive redundancy. Such choices may consider frequency, spatial (e.g., location) or temporal (e.g., expiration dates or last time offered) characteristics of promotions to maximize independence or differences of promotions. By aggregating the vendors and/or promotions, system collectively and more preferably, automates the processing and collection of advertisements/promotions, and more importantly, as shown in FIG. 12, amplifies the efforts of each recipient 1204 by collectively, and preferably automatically, redistributing promotions 1205 to one or more recipients.

Preferably, the system will automatically distribute promotions to recipients. Such methods can be based on simple pairing of requests by recipients and/or vendors, matching of characteristics identified by system or provided by recipients/vendors or via a database or such other pattern matching systems, machine learning or pattern recognition systems, and the like. Pattern recognition algorithms include classification algorithms (supervised algorithms predicting categorical labels), clustering algorithms, regression algorithms, categorical sequence labeling algorithms, real-valued sequence labeling algorithms, parsing algorithms, general algorithms for predicting arbitrarily-structured labels, ensemble learning algorithms, and the like. Machine learning algorithms include decision tree learning, association rule learning, artificial neural networks, genetic programming, inductive logic programming, support vector machines, clustering, bayesian networks, reinforcement learning, representation learning, and the like.

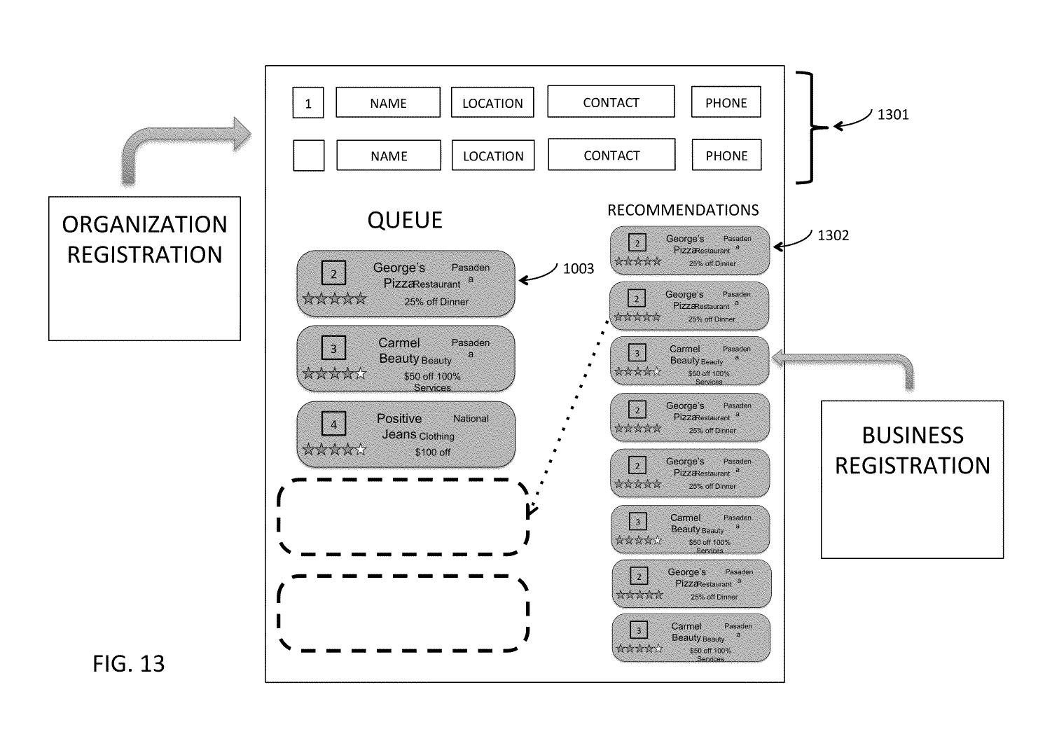

Preferably, recipient 1201 is provided the option to select desired vendors 1203, preferably through an automated queue system as shown in FIG. 13. System will query 1301 recipient to identify potential vendors 1302 who may be interested in participating, and/or will alternatively be provided a list of recommended vendors in system database 1302. Potential vendors 1302 can be automatically invited by system to participate through email, mail, phone or other invitation. Recipient is provided information about vendors 1302 and/or promotions, specifically about the businesses, advertisers, promotions, advertisements, recommendations, ratings, type of business, location, etc. recipient then creates a queue of upcoming vendors/promotions 1303 for recipient to utilize which can be easily added and removed by dragging and dropping from the recommendation list 1302. Recipient's choices can be stored and analyzed to further learn recipient's preference. In one such embodiment, the system is analogous to the system used to pick and store movie choices in a queue, wherein the present invention would have vendors identifying desirable partner entity/organizations and the entity/organization choosing in their queue desirable vendors and/or promotions.

### III. Computer Embodiment

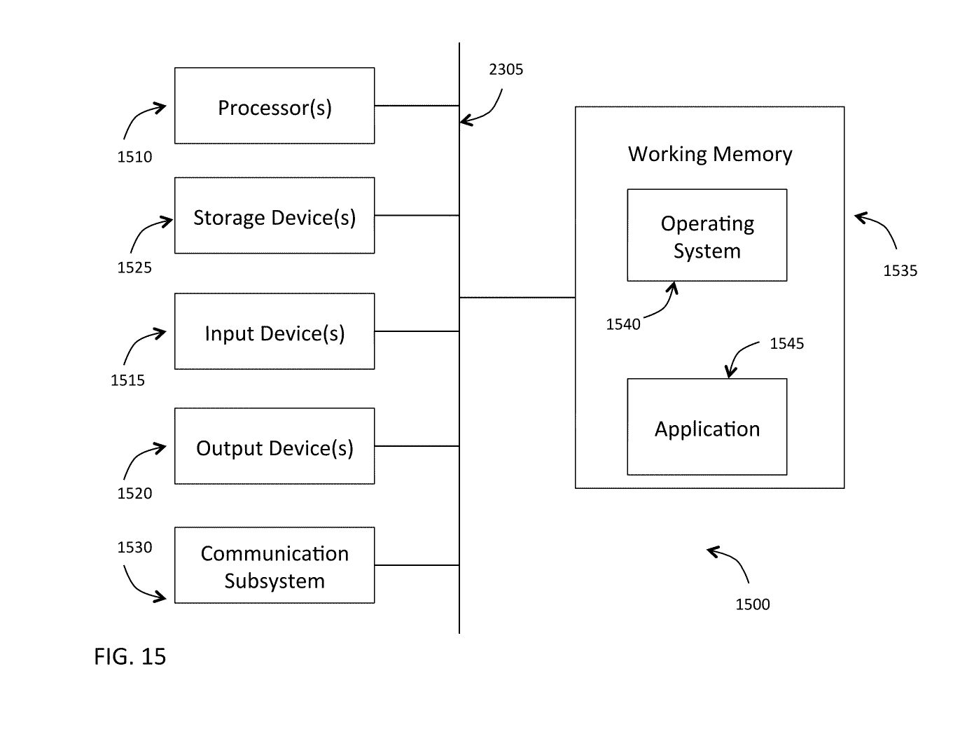

FIG. 15 provides a schematic illustration of one embodiment of a computer system 1500 that can perform the methods of the invention, as described herein. It should be noted that FIG. 15 is meant only to provide a generalized illustration of various components, any or all of which may be utilized as appropriate. FIG. 15, therefore, broadly illustrates how individual system elements may be implemented in a relatively separated or relatively more integrated manner.

The computer system 1500 is shown comprising hardware elements that can be electrically coupled via a bus 1505 (or may otherwise be in communication, as appropriate). The hardware elements can include one or more processors 1510, including without limitation, one or more general purpose processors and/or one or more special purpose processors (such as digital signal processing chips, graphics acceleration chips, and/or the like); one or more input devices 1515, which can include without limitation a mouse, a keyboard and/or the like; and one or more output devices 1520, which can include without limitation a display device, a printer and/or the like.

The computer system 1500 may further include (and/or be in communication with) one or more storage devices 1525, which can comprise, without limitation, local and/or network accessible storage and/or can include, without limitation, a disk drive, a drive array, an optical storage device, a solid state storage device such as a random access memory (“RAM”) and/or a read-only memory (“ROM”), which can be programmable, flash updateable and/or the like. The computer system 1500 might also include a communications subsystem 1530, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 1530 may permit data to be exchanged with a network (such as the network described below, to name one example), and/or any other devices described herein. In many embodiments, the computer system 1500 will further comprise a working memory 1535, which can include a RAM or ROM device, as described above.

The computer system 1500 also can comprise software elements, shown as being currently located within the working memory 1535, including an operating system 1540 and/or other code, such as one or more application programs 1545, which may comprise computer programs of the invention, and/or may be designed to implement methods of the invention and/or configure systems of the invention, as described herein. Merely by way of example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 1525 described above. In some cases, the storage medium might be incorporated within a computer system, such as the system 1500. In other embodiments, the storage medium might be separate from a computer system (i.e., a removable medium, such as a compact disc, etc.), and is provided in an installation package, such that the storage medium can be used to program a general-purpose computer with the instructions/code stored thereon. These instructions might take the form of executable code, which is executable by the computer system 1500 and/or might take the form of source and/or installable code, which, upon compilation and/or installation on the computer system 1500 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

In one aspect, the invention employs a computer system (such as the computer system 1500) to perform methods of the invention. According to a set of embodiments, some or all of the procedures of such methods are performed by the computer system 1500 in response to processor 1510 executing one or more sequences of one or more instructions (which might be incorporated into the operating system 1540 and/or other code, such as an application program 1545) contained in the working memory 1535. Such instructions may be read into the working memory 1535 from another machine-readable medium, such as one or more of the storage device(s) 1525. Merely by way of example, execution of the sequences of instructions contained in the working memory 1535 might cause the processor(s) 1510 to perform one or more procedures of the methods described herein.

The terms “machine-readable medium” and “computer readable medium,” as used herein, refer to any medium that participates in providing data that causes a machine to operate in a specific fashion. In an embodiment implemented using the computer system 1500, various machine-readable media might be involved in providing instructions/code to processor(s) 1510 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media includes, for example, optical or magnetic disks, such as the storage device(s) 1525. Volatile media includes, without limitation, dynamic memory, such as the working memory 1535. Transmission media includes coaxial cables, copper wire and fiber optics, including the wires that comprise the bus 1505, as well as the various components of the communications subsystem 1530 (and/or the media by which the communications subsystem 1530 provides communication with other devices). Hence, transmission media can also take the form of waves (including without limitation radio, acoustic and/or light waves, such as those generated during radio wave and infrared data communications).

Common forms of physical and/or tangible computer-readable media include, for example, a floppy disk, a flexible disk, a hard disk, magnetic tape, or any other magnetic medium, a CD-ROM, any other optical medium, punchcards, papertape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of machine-readable media may be involved in carrying one or more sequences of one or more instructions to the processor(s) 1510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1500. These signals, which might be in the form of electromagnetic signals, acoustic signals, optical signals and/or the like, are all examples of carrier waves on which instructions can be encoded, in accordance with various embodiments of the invention.

The communications subsystem 1530 (and/or components thereof) generally will receive the signals, and the bus 1505 then might carry the signals (and/or the data, instructions, etc., carried by the signals) to the working memory 1535, from which the processor(s) 1510 retrieves and executes the instructions. The instructions received by the working memory 1535 may optionally be stored on a storage device 2325 either before or after execution by the processor(s) 1510.

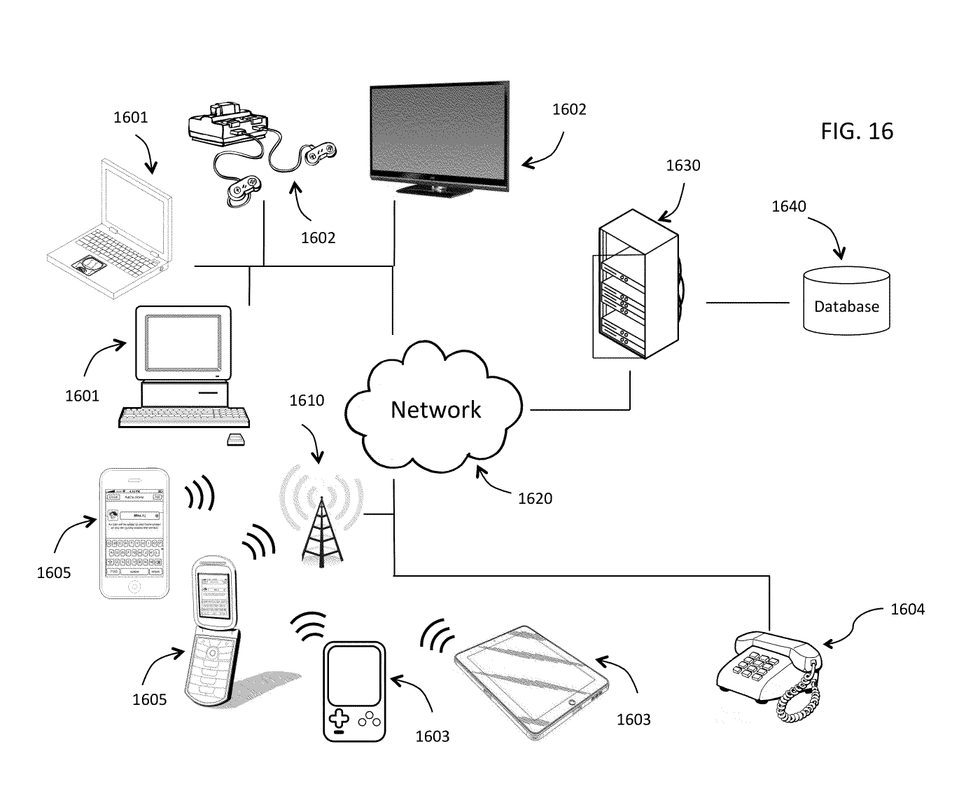

Merely by way of example, FIG. 16 illustrates a schematic diagram of devices to access and implement the invention system 400 (100). The system 400 can include one or more user computers 1601. The user computers 1601 can be general-purpose personal computers (including, merely by way of example, personal computers and/or laptop computers running any appropriate flavor of Microsoft Corp.'s Windows™ and/or Apple Corp.'s Macintosh™ operating systems) and/or workstation computers running any of a variety of commercially available UNIX™ or UNIX-like operating systems. These user computers 1601 can also have any of a variety of applications, including one or more applications configured to perform methods of the invention, as well as one or more office applications, database client and/or server applications, and web browser applications. Alternatively, the user computers 1601 can be any other electronic device, such as a thin-client computer, media computing platforms 1602 (e.g., gaming platforms, or cable and satellite set top boxes with navigation and recording capabilities), handheld computing devices (e.g., PDAs, tablets or handheld gaming platforms) 1603, conventional land lines 1604 (wired and wireless), mobile (e.g., cell or smart) phones 1605 or tablets, or any other type of portable communication or computing platform (e.g., vehicle navigation systems), capable of communicating via a network (e.g., the network 1620 described below) and/or displaying and navigating web pages or other types of electronic documents. Although the exemplary system 1600 is shown with a user computer 1605, any number of user computers can be supported.

Certain embodiments of the invention operate in a networked environment, which can include a network 1620. The network 1620 can be any type of network familiar to those skilled in the art that can support data communications using any of a variety of commercially available protocols, including without limitation TCP/IP, SNA, IPX, AppleTalk, and the like. Merely by way of example, the network 16200 can be a local area network (“LAN”), including without limitation an Ethernet network, a Token-Ring network and/or the like; a wide-area network (WAN); a virtual network, including without limitation a virtual private network (“VPN”); the Internet; an intranet; an extranet; a public switched telephone network (“PSTN”); an infrared network; a wireless network 1610, including without limitation a network operating under any of the IEEE 802.11 suite of protocols, the Bluetooth™ protocol known in the art, and/or any other wireless protocol; and/or any combination of these and/or other networks.

Embodiments of the invention can include one or more server computers 1630. Each of the server computers 1630 may be configured with an operating system, including without limitation any of those discussed above, as well as any commercially (or freely) available server operating systems. Each of the servers 1630 may also be running one or more applications, which can be configured to provide services to one or more clients and/or other servers.

Merely by way of example, one of the servers 1630 may be a web server, which can be used, merely by way of example, to process requests for web pages or other electronic documents from user computers 1601. The web server can also run a variety of server applications, including HTTP servers, FTP servers, CGI servers, database servers, Java™ servers, and the like. In some embodiments of the invention, the web server may be configured to serve web pages that can be operated within a web browser on one or more of the user computers 1601 to perform methods of the invention.

The server computers 1630, in some embodiments, might include one or more application servers, which can include one or more applications accessible by a client running on one or more of the client computers and/or other servers. Merely by way of example, the server(s) 1630 can be one or more general purpose computers capable of executing programs or scripts in response to the user computers and/or other servers, including without limitation web applications (which might, in some cases, be configured to perform methods of the invention). Merely by way of example, a web application can be implemented as one or more scripts or programs written in any suitable programming language, such as Java™, C, C#™ or C++, and/or any scripting language, such as Perl, Python, or TCL, as well as combinations of any programming/scripting languages. The application server(s) can also include database servers, including without limitation those commercially available from Oracle™, Microsoft™, Sybase™, IBM™ and the like, which can process requests from clients (including, depending on the configuration, database clients, API clients, web browsers, etc.) running on a user computer and/or another server. In some embodiments, an application server can create web pages dynamically for displaying the information in accordance with embodiments of the invention. Data provided by an application server may be formatted as web pages (comprising HTML, Javascript, etc., for example) and/or may be forwarded to a user computer via a web server (as described above, for example). Similarly, a web server might receive web page requests and/or input data from a user computer and/or forward the web page requests and/or input data to an application server. In some cases a web server may be integrated with an application server.

In accordance with further embodiments, one or more servers 15630 can function as a file server and/or can include one or more of the files (e.g., application code, data files, etc.) necessary to implement methods of the invention incorporated by an application running on a user computer and/or another server. Alternatively, as those skilled in the art will appreciate, a file server can include all necessary files, allowing such an application to be invoked remotely by a user computer and/or server. It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 1640. The location of the database(s) 1640 is discretionary. Merely by way of example, a database might reside on a storage medium local to (and/or resident in) a server (and/or a user computer). Alternatively, a database can be remote from any or all of the computers, so long as the database can be in communication (e.g., via the network) with one or more of these. In a particular set of embodiments, a database can reside in a storage-area network (“SAN”) familiar to those skilled in the art. (Likewise, any necessary files for performing the functions attributed to the computers can be stored locally on the respective computer and/or remotely, as appropriate.) In one set of embodiments, the database can be a relational database, such as an Oracle™ database, that is adapted to store, update, and retrieve data in response to SQL-formatted commands. The database might be controlled and/or maintained by a database server, as described above, for example.

While the invention has been particularly shown and described with reference to specific embodiments thereof, it will be understood by those skilled in the art that changes in the form and details of the disclosed embodiments may be made without departing from the spirit or scope of the invention. For example, embodiments have been described herein with reference to the use of conventional landlines and cellular phones. Additionally, the various embodiments of the invention as described may be implemented in the form of software running on a general purpose computer, in the form of a specialized hardware, or combination of software and hardware. It will be understood, however, that the invention is not so limited. That is, embodiments are contemplated in which a much wider diversity of communication devices may be employed in various combinations to effect redemption.

In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A proactive registration system to add new vendors and member-based entities comprising one or more servers having a memory storage device for storing a plurality of vendors and entities and a first processing means for adding new vendors and a second processing means for adding new entities;
a. wherein first processing means comprising identifying one or more new entities with members having the target characteristics of the vendor, wherein target characteristics are selected from geographic segmentations, demographic/socio-economic segmentation, psychographic segmentation, behavioral segmentation or product-related segmentation; contacting one or more new entities to register with the system, and thereafter, registering new entities with the system; and
b. wherein second processing means comprising identifying one or more new vendors having target characteristics of the entities members, wherein target characteristics are selected from geographic segmentations, demographic/socio-economic segmentation, psychographic segmentation, behavioral segmentation or product-related segmentation, contacting one or more new vendors to register with the system, and thereafter, registering new vendors with the system.

2. The registration system of claim 1 or 4, wherein the first processing means further comprises presenting the entity with one or more promotions by the vendor to encourage registration by the entity.

3. The registration system of claim 2, wherein the first processing means further comprises presenting the entity with 2 or more vendors.

4. The registration system of claim 1, wherein the second processing means further comprises presenting the vendor with one or more entities in a geographic segment.

5. The registration system of claim 2, wherein at least one promotion is presented to members of the entity.

6. The registration system of claim 5, wherein at least one member identifies promotions and/or vendors.

7. The registration system of claim 6, wherein member is provided an incentive for identifying new vendors.

8. A promotion distribution platform comprising one or more servers having a memory storage device for storing a plurality of vendors and member-based entities and a processing means for collectively aggregating promotional rewards and selectively distributing the rewards to a network of members of an entity for increasing engagement and participation in charitable and non-profit activities, for example, donating or volunteering, for a member-based entity.

9. The promotion distribution platform of claim 8, further comprising an online collective rewards network and method for providing relevant rewards to members of an entity, particularly to a non-profit, charitable institution or school, or school organization.

10. The promotion distribution platform of claim 8, wherein such rewards are derived by pairing the distinguishable characteristics of the members of the entity with the target characteristics of the vendor, such characteristics include geographic segmentations (their location), demographic/socio-economic segmentation (gender, age, income occupation, education, sex, household size, and stage in the family life cycle), psychographic segmentation (similar attitudes, values, and lifestyles), behavioral segmentation (occasions, degree of loyalty), product-related segmentation (relationship to a product), affiliations or relationships (such as membership, alumnus status, parent, grandparent, sibling or other relationship) and the like.

11. The promotion distribution platform of claim 8, wherein members of an entity are presented with a reward for participating in a campaign for the entity.

12. The promotion distribution platform of claim 11, wherein the reward is a promotion from a vendor.

13. The promotion distribution platform of claim 12, wherein engagement and/or participation is measured by a member's donation, volunteering or the undertaking of an activity in response to a campaign.
